(19) United States
(12) Patent Application Publication
(10) Pub. No.: US 2012/0263805 A1
(43) Pub. Date: Oct. 18, 2012

(54) Detergent, Cleaning Agent or Disinfectant Containing Hydrolyzates Made of Plant Extracts

(75) Inventor: Michael Popp, Lauf-Heuchling (DE)

(73) Assignee: Bionorica SE, Neumarkt (DE)

(21) Appl. No.: 13/496,404

(22) PCT Filed: Sep. 16, 2010
(86) PCT No.: PCT/EP2010/005701

§ 371 Date: Jun. 29, 2012

(30) Foreign Application Priority Data
Sep. 16, 2009 (DE) 10 2009 041 753.2

(51) Int. Cl. A01N 65/08; A01P 1/00; A01N 65/30

(52) U.S. Cl. 424/725

(57) ABSTRACT

The invention relates to a detergent, cleaning agent or disinfectant containing at least one plant hydrolyzate, in particular selected from the group including Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary) Rumicis herba (sorrel herb), Salix sp. (willow), Salvia miltiorrhiza (red sage), Sambucus nigra L. (black elder), Saposhnikovia divaricata (slier), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus cactus (monk's pepper), and Vitis vinifera (common grape vine).

The invention relates to a detergent, cleaning agent, or disinfectant containing at least one plant hydrolysate, in particular selected from the group Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (Eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary), Rumicis herba (sorrel herb), Salix sp. (willow), Salvia miltiorrhiza (red sage), Sambucus nigra L. (black elder), Saposhnikovia divaricata (siler), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus cactus (monk's pepper), Vitis vinifera (common grapevine).

Plant extracts in cleaning agents are described in the prior art, e.g., in DE 10 2007 009 375 A1.

High requirements are to be placed on a modem detergent, cleaning agent, or disinfectant. In particular, such agents are to be able to treat food and water carefully and are not to represent a potential hazard (e.g., toxicity) for humans and animals.

The invention relates to a detergent, cleaning agent, or disinfectant containing a hydrolysate made of an extract of at least one plant material selected from the respective genera, in particular the species

Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (Eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary), Rumicis herba (sorrel herb), Salix sp. (willow), Salvia miltiorrhiza (red sage), Sambucus nigra L. (black elder), Saposhnikovia divaricata (siler), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus castus (monk's pepper), Vitis vinifera (common grapevine), or a mixture or (sub) combination thereof, and a method for the production and the use thereof.

The mentioned healing plants have already been used as pharmaceuticals, e.g., Sinupret®, Tonsipret®, Bronchipret®, or Canephron® (registered trademarks of BIONORICA AG).

Sinupret® is a known mixture of five plant drugs, namely Verbena officinalis L. (vervain), Sambucus nigra L. (black elder), Primula veris L. (cowslip), Rumicis herba (sorrel herb), Gentiana lutea L. (great yellow gentian).

Bronchipret® is an already known herbal medicine, which contains thyme in combination with primrose or ivy. Tonsipret® is a known mixture of three plant drugs, namely Guaiacum officinalis, Phytolacca americana (American pokeweed), and Capsicum annuum (pepper).

Canephron® is a known mixture of three plant drugs, namely Centaurium erythraea (common centaury), Levisticum officinalis (lovage; powder of lovage roots), Rosmarinus officinalis (rosemary; powder of rosemary leaves), which is provided from these plant materials. Through a combination of these mentioned healing plants, a composition is obtained, using which an effect sufficient for medical and dermatological purposes can be achieved. The ground crude drugs and ethanol-aqueous extracts or dry extracts produced therefrom (producible by withdrawing the solvent/extracting agent under reduced pressure, for example) of the above-mentioned plants have proven themselves through their healing power, which is exclusively originates from a plant base. The healing plants used in Bionorica® are carefully selected, assayed, and further processed. Bionorica® achieves the uniform quality of the pharmaceuticals through optimally worked out cultivation and harvesting strategies and extremely strict quality control.

Angelica dahurica, Angelica sinensis, Artemisia scoparia, Astragalus membranaceus (var. mongolicus), Leonurus japonicus, Salvia miltiorrhiza, Saposhnikovia divaricata, Scutellaria baicalensis, and Siegesbeckia pubescens are known representatives of traditional Chinese medicine (TCM) and are described for numerous indications.

Furthermore, plant genera and species exist, such as Armoracia rusticana, Capsicum sp., Capsicum annuum, Cistus incanus, Echinacea angustifolia, Echinacea purpurea, Galphimia glauca, Hedera helicis, Melia toosendan, Olea europaea, Pelargonium sp., Phytolacca americana, Primula veris, Salix sp., Thymus L., Vitex agnus castus, and Vitis vinifera, to each of which a pharmaceutical effect is ascribed in various indications.

Infection-relevant pathogens exist, such as Staphylococcus aureus, Staphylococcus epidermidis, Streptococcus pyogenes, Streptococcus pneumoniae, or Haemophilus influenzae. Among them is also a Staphylococcus aureas strain that is resistant to methicillin, called MRSA. Standard antibiotics such as beta-lactam antibiotics, for example oxacillin, penicillin and amoxicillin, increasingly no longer have an effect on these bacteria, because they have developed resistances through the excessive use of antibiotics, which do not fully destroy the pathogenic agents. Such bacteria represent an additional risk in the case of skin-mucosa penetration, which could result in lung inflammations, wound infections, and blood poisoning or other life-threatening infections.

It is the object of the present invention to provide a detergent, cleaning agent, or disinfectant, which prevents the nonspecific spread of infectious agents.

Surprisingly, detergents, cleaning agents, or disinfectants containing hydrolysates of extracts of at least one plant drugs from the respective genera, in particular the species Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (Eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary), Rumicis herba (sorrel herb), Salix sp. (willow), Salvia miltiorrhiza (red sage), Sambucus nigra L. (black elder), Saposhnikovia divaricata (slier), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus castus (monk's pepper), Vitis vinifera (common grapevine), display an effective antibacterial effect.

The invention relates to a detergent, cleaning agent, or disinfectant containing a hydrolysate made of at least one extract, which is produced by extraction from dried plant material from:

a.) at least one of the plants selected from the group comprising:
the respective genera, in particular the species Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (Eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary), Rumicis herba (sorrel herb), Salix sp. (willow), Salvia miltiorrhiza (red sage), Sambucus nigra L. (black elder), Saposhnikovia divaricata (siler), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus cactus (monk's pepper), Vitis vinifera (common grapevine); and a mixture or subcombination thereof,
   the hydrolysate being obtainable from the extract by hydrolytic treatment using a mineral acid.

Therefore, the invention also relates to detergents, cleaning agents, or disinfectants containing a hydrolysate made of an extract, which is produced by extraction from dried plant material, the hydrolysate being obtainable from the extract by hydrolytic treatment using a mineral acid.

The plant (drugs) according to the invention can be obtained, as is typical and known for the respective plant drugs, from preferred plant parts, such as leaves, roots, etc.

A preferred hydrolysate is characterized in that the extracts can be produced from the plant material by means of an extracting agent comprising 40 to 60% by volume, in particular 50% by volume ethanol and 40 to 60% by volume, in particular 50% by volume water over 24 hours while stirring and subsequent vacuum evaporation of the solvent.

A further preferred embodiment of the invention is a hydrolysate which can be obtained by the hydrolytic treatment of the plant extracts using hydrochloric acid as the mineral acid, in particular using hydrochloric acid having a concentration of 1 M to 10 M, preferably 6 to 9 M, in particular approximately 8 M, at 80° C. to 100° C., in particular approximately 90° C., for 30 minutes to 120 minutes, in particular 40 minutes to 60 minutes, preferably approximately 45 minutes. In the final solution, the concentration of the hydrochloric acid is preferably 1 to 4 M, in particular 1 to 2 M, in particular 1.3 M.

It is preferable to carry out the hydrolytic treatment of the extracts in the presence of ethanol, in particular ethanol diluted with water, preferably 50% by volume ethanol.

The admixture of the extracts with the mineral acid can be performed after removal of the extraction agent or with the extraction agent.

Within the context of this invention, the term “hydrolysate” denotes an aqueous phase obtained from the extract of the plant (plant drug) according to the invention, in which the hydrolysis products are enriched. The hydrolysis preferably takes place under the action of acid, such as hydrochloric acid, phosphoric acid, sulfuric acid, mineral acid, in particular diluted mineral acid. The extract can be obtained, for example, by means of an aqueous/ethanolic extraction from a plant (plant drug), admixed by means of aqueous acid, evaporated to dryness, and subsequently received in water. The hydrolysis causes the chemical cleavage of ingredients, formally hydrogen and hydroxide being added to the respective cleavage product. The hydrolysis brings about a change of the substance composition of the hydrolysate as compared to the previously known aqueous/ethanolic extracts.

It came as a complete surprise when it was found that the detergents, cleaning agents, or disinfectants according to the invention, which contain hydrolysates, have an antibacterial effect.

The non-toxic compatibility of the detergents, cleaning agents, or disinfectants according to the inventions for animals and humans is particularly advantageous. Furthermore, the detergent, cleaning aging, or disinfectant according to the invention is not mutagenic or carcinogenic, is odor and taste neutral, is biologically degradable, and is non-foaming.

In the meaning of this invention, “detergent, cleaning agent, or disinfectant” means that these can be used outside the human or animal body.

This allows the preferred use of these agents in the field of all foods, including beverages, such as wine, soft drinks, juices, milk, and oil, margarine, water, flavors, and essences and in the point of care field or the medical field.

Furthermore, the detergents, cleaning agents, or disinfectants according to the invention are suitable for animal husbandry/meat processing, fish farming, shrimp farming, and agriculture, including aquariums and terrariums.

The detergents, cleaning agents, and disinfectants according to the invention can also be used for the treatment of surfaces and materials, in particular fabrics and cloths of any type, whether they are industrial surfaces, such as metals, steel, sheet metal, and plastics, tiles, clay, rocks, ceramic, porcelain, glass, glass fibers, wood, cellulose, paper, textiles, nonwoven materials of all types, coated surfaces, organic surfaces, such as leather, and composite materials, including mixtures thereof.

Such surfaces are components of appliances, machines, tools, instruments, vehicles, ships, aircraft, furniture, interiors, packages, shafts, pipes, cables, transport vehicles, ambulances, clothing, bedding, and objects of daily use.

Furthermore, surfaces in dairies, cheese factories, bakeries, butcher shops, inter alia.

Furthermore, the treatment of water is preferred, e.g., in closed and open systems, whether hot water or cold water, industrial water, wastewater, drinking water (e.g., in shower facilities, beverages), thermal water, mineral water, and swimming pools, pools, sewage treatment facilities, water disinfection, etc.

The terms “water” and “food” are defined according to the relevant legal definitions (e.g., regulation (EG) number 178/2002).

Therefore, the detergents, cleaning agents, and disinfectants according to the invention also relate to the treatment of water and foods, in that these agents are added to the water or food.

Furthermore, the detergents, cleaning agents, or disinfectants can be used in the point of care field. This relates to hospitals, ambulances, doctors offices, intensive care units, sewage treatment facilities, hotels, restaurants, schools, domestic use, solariums, saunas, washrooms, chairs, couches, i.e., any type of hygiene field.

A further field of application is air conditioning and ventilation facilities, and air and water filters.

Therefore, the invention relates to the utilization or use of the detergents, cleaning agents, or disinfectants according to the invention in the hygiene field, in particular water hygiene, hospital hygiene, food hygiene, product hygiene, and machine hygiene.

In a preferred embodiment of a detergent, cleaning agent, or disinfectant, the content of hydrolysates according to the invention in a composition is 0.001 or 0.01 or 0.1 to 1% by weight or up to 5% by weight or up to 10% by weight to 15% by weight or up to 30% by weight, preferably 0.01-10% by weight, or preferably 0.1-5% by weight.

The hydrolysates of the present invention generally have a significant antibacterial effect, which in the therapeutic range thereof is comparable to an antibiotic control agent comprising amoxicillin and clavulanic acid (mass ratio of 6:1). Therefore, these hydrolysates benefit from a cleaning and disinfecting function.

The hydrolysates were tested and found to be effective against the following pathogens within the context of the present invention:

Staphylococcus aureus (ATCC 25923), Staphylococcus epidermidis (ATCC 12228), Streptococcus pneumoniae (DSMZ 20566), Streptococcus pyogenes (DSMZ 20565), Streptococcus mutans (ATCC 35668), Haemophilus influenzae (DSMZ 4690), Klebsiella pneumoniae (ATCC 13883), and Enterococcus casseliflavus (VRE) (DSMZ 20680) as well as against the intestinal bacteria Escherichia coli (ATCC 25922), Enterococcus faecalis (VRE) (ATCC 19433), and Pseudonomas aeruginosa.

Furthermore, the hydrolysates in the scope of the present invention are suitable against Legionella and biofilms (e.g., shower facilities, thermal baths, drinking water supply, etc.).

The detergents, cleaning agents, or disinfectants according to the invention can be provided in solid form as powders, granules, tablets, or in liquid form as acid, aqueous, aqueous/acid, aqueous/organic, aqueous/acid/organic, aqueous/alcoholic, aqueous/acid/alcoholic, or organic formulations. Further embodiments can be: emulsions, dispersions, gels, and suspensions. The detergents, cleaning agents, or disinfectants according to the invention can be of different types. Solid detergents are preferred, in particular heavy-duty detergents for white and colored laundry and mild detergents for washing machines and for hand laundry. Liquid detergents, dishwashing detergents for dishwashers, dishwashing liquids, liquid all-purpose cleaners, bathtub cleaners, and glass cleaners, and floor cleaners are also preferred. A preferred embodiment of the invention is solid detergents, as powder detergents, granulated detergents, or in the form of tablets, liquid detergents, are dishwashing liquids, containing detergents, cleaning agents, or disinfectants according to the invention in weight quantities of 0.01 to 30%, preferably 0.1 to 5%.

In a preferred embodiment, the detergents, cleaning agents, or disinfectants according to the invention contain a further non-ionic surfactant from the class of alcohol EO (ethylene oxide)/PO (propylene oxide) adducts having high/low EO content and low/high PO content. Examples are the adducts of an average of 1 to 50, preferably 4 to 25, particularly preferably 4 to 20 moles ethylene oxide to capron alcohol, capryl alcohol, 2-ethylhexyl alcohol, caprin alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, and brassidyl alcohol and the technical mixtures thereof, which occur, for example, upon the high-pressure hydrogenation of industrial methyl esters based on fats and oils or aldehydes from the Roelen oxo-synthesis and as monomer fractions in the dimerization of unsaturated fatty alcohols. Adducts of 4 to 25 ethylene oxide to industrial fatty alcohols having 12 to 18 carbon atoms, for example, coconut, palm, palm kernel, or tallow fatty alcohol, are preferred. The detergents, cleaning agents, or disinfectants according to the invention can contain further surfactants of a non-ionic, anionic, cationic, or amphoteric nature as well as typical auxiliary materials and additives in various quantities. A nonexhaustive list of further non-ionic surfactants which comes into consideration includes polyethylene, polypropylene, and polybutylene oxide adducts of alkyl phenols having 6 to 12 carbon atoms in the alkyl chain, addition products of ethylene oxide with a hydrophobic base, formed from the condensation of propylene oxide with propylene glycol or addition products of ethylene oxide with a reaction product of propylene oxide and ethylene diamine. Instead of or in addition to the non-ionic surfactants, the detergents, cleaning agents, or disinfectants according to the invention can also contain anionic surfactants. Above all straight-chain and branched alkyl sulfates, alkyl sulfonates, alkyl carboxylates, alkyl phosphates, alkyl ester sulfonates, aryl alkyl sulfonates, alkyl ether sulfates, and mixtures of the mentioned compounds come into consideration as the anionic surfactants. Secondary alkane sulfonates are preferred. Secondary alkane sulfonates are surfactants of the formula R—SO₃M, whose alkyl group R is saturated or unsaturated, linear or branched, and which can also carry hydroxyl groups, the terminal carbon atoms of the alkyl chain not having a sulfonate group.

Secondary alkane sulfonates are preferred having linear alkyl groups having 9 to 25 carbon atoms, preferably having 10 to 20 carbon atoms, particularly preferably having 13 to 17 carbon atoms. The counter ion M can be sodium, potassium, ammonium, mono-, di-, or tri-alkanol ammonium, calcium, magnesium ions or mixtures thereof. Sodium salts of the secondary alkane sulfonates are preferred.

Alkyl ester sulfonates also come into consideration. Alkyl ester sulfonates represent linear esters of C₈-C₂₀ carboxylic acids (i.e., fatty acids), which are sulfonated by SO₃, as described in “The Journal of the American Oil Chemists Society”, 52 (1975), pp. 323-329. Suitable starting materials are natural fat derivatives, such as tallow or palm oil fatty acid. Alkyl sulfates and alkyl ether sulfates are also used. Alkyl sulfates are water soluble salts or acids of the formula ROSO₃M, in which R preferably denotes a C₁₀-C₂₄ hydrocarbon group, preferably an alkyl or hydroxy alkyl group having 10 to 20 carbon atoms, particularly preferably a C₁₂-C₁₈ alkyl or hydroxyalkyl group. M is hydrogen or a cation, e.g., an alkali metal cation (e.g., sodium, potassium, lithium) or ammonium or substituted ammonium, e.g., a methyl, dimethyl, and trimethyl ammonium cation or a quaternary ammonium cation, such as tetramethyl ammonium and dimethyl piperidinium cation and quaternary ammonium cations, derived from alkyl amines such as ethyl amine, diethyl amine, triethyl amine, and mixtures thereof. Alkyl chains having C₁₂-C₁₆ are preferred for low washing temperatures, (e.g., less than approximately 50° C.) and alkyl chains having C₁₆-C₁₈ are preferred for higher washing temperatures (e.g., greater than approximately 50° C.).

The alkyl ether sulfates are water soluble salts or acids of the formula RO(A)ₘSO₃M, in which R denotes an unsubstituted C₁₀-C₂₄ alkyl or hydroxy alkyl group having 10 to 24 carbon atoms, preferably a C₁₂-C₂₀ alkyl or hydroxy alkyl group, particularly preferably a C₁₂-C₁₈ alkyl or hydroxy alkyl group. A is an ethoxy or propoxy unit, m is a number greater than 0, typically between approximately 0.5 and approximately 6, particularly preferably between approximately 0.5 and approximately 3, and M is a hydrogen atom or a cation such as a metal cation (e.g., sodium, potassium, lithium, calcium, magnesium, etc.), ammonium or a substituted ammonium cation. Examples of substituted ammonium cations are methyl, dimethyl, trimethyl ammonium and quaternary ammonium cations, such as tetramethyl ammonium and dimethyl piperidinium cations and those derived from alkyl amines such as ethyl amine, diethyl amine, triethyl amine, mixtures thereof, and the like. The following are mentioned as examples: C₁₂-C₁₈-alkyl-polyethoxylate-(1,0)-sulfate, C₁₂-C₁₈-alkylpolyethoxylate (2,25) sulfate, C₁₂-C₁₈-alkyl-polyethoxylate (3,0) sulfate, C₁₂-C₁₈-alkylpolyethoxylate (4,0) sulfate, the cation being sodium or potassium.

Other anionic surfactants which are useful for use in the detergents, cleaning agents, or disinfectants according to the invention are C₈-C₂₄ olefinic sulfonates, sulfonated polycarboxylic acids, produced by sulfonation of the pyrolysis products of alkaline earth metal citrates, as described, for example, in GB 1,082,179, alkyl glycerin sulfates, fatty acyl glycerin sulfates, oleylglycerin sulfates, alkylphenol ether sulfates, primary paraffin sulfonates, alkyl phosphates, alkylether phosphates, isethionates, such as acylisethionate, N-acyltauride, alkyl succinamates, sulfosuccinates, monoesters of sulfosuccinates (particularly saturated and unsaturated C₁₂-C₁₈ monoesters) and diesters of sulfosuccinates (particularly saturated and unsaturated C₁₂-C₁₈ diesters); acyl sarcosinates, sulfates of alkyl polysaccharides such as sulfates of alkyl olyglycosides, branched primary alkyl sulfates and alkyl polyethoxycarboxylates such as those of the formula RO(CH₂CH₂)ₖCH₂COO-M, in which R is C₈-C₂₂ alkyl, k is a number from 0 to 10, and M is a cation forming a soluble salt. Resin acids or hydrogenated resin acids, such as rosin or hydrogenated rosin or tall oil resin and tall oil resin acids, are also usable. Further examples are described in “Surface Active Agents and Detergents” (volumes I and II, Schwartz, Perry, and Berch). A plurality of such surfactants is disclosed in U.S. Pat. No. 3,929,678.

Examples of amphoteric surfactants which can be used in the formulations of the present invention are above all those which are broadly described as derivatives of aliphatic secondary and tertiary amines, in which the aliphatic group can be linear or branched and in which one of the aliphatic substituents contains between 8 and 18 carbon atoms and contains an anionic, water-soluble group, such as carboxy, sulfonate, sulfate, phosphate, or phosphonate. Further preferred amphoteric surfactants are alkyl dimethylbetaine, alkyl amidobetaine, and alkyl dipolyethoxybetaine having an alkyl group which can be linear or branched having 8 to 22 carbon atoms, preferably having 8 to 18 carbon atoms, and particularly preferably having 12 to 18 carbon atoms.

The detergents, cleaning agents, or disinfectants according to the invention can contain further auxiliary materials and additives, as are typically used in such agents. The detergents, cleaning agents, or disinfectants according to the invention contain, depending on the intended application, in addition to the mentioned surfactants, also the respective specific auxiliary materials and additives, for example, builders, salts, bleaching agents, bleach activators, optical tighteners, complex formers, discoloration inhibitors, solubilizers, acid additives, enzymes, thickeners, preservatives, fragrances and colorants, pearlescent agents, foam inhibitors, sequestering agents. Neutral or in particular alkaline reactive salts which precipitate calcium ions or are capable of forming complexes are suitable as organic and inorganic builders. Suitable and in particular ecologically harmless builder substances, such as fine crystalline, synthetic water-containing zeolites of the type NaA, which have a calcium binding capability in the range of 100 to 200 mg CaO/g, are preferably used. In non-aqueous systems, layered silicates are preferably used. Zeolites and the layered silicates can be included in a quantity up to 20% by weight in the agent. Usable organic builder substances are, for example, the percarboxylic acids, which are preferably used in the form of their sodium salts, such as citric acid and nitriloacetate (NTA), ethylene diamine tetraacetic acid, if such a use is not objected to for ecological reasons. Similarly thereto, polymer carboxylase and the salts thereof can also be used. These include, for example, the salts of homopolymeric or co-polymeric polyacrylates, polymethyl acrylates, and in particular copolymers of acrylic acid with maleic acid, preferably those made of 50% to 10% maleic acid, and also polyvinylpyrrolidone and urethanes. The relative molecular mass of the homopolymers is generally between 1000 and 100,000, that of the copolymers between 2000 and 200,000, preferably 50,000 to 120,000, in relation to the free acid, in particular water-soluble polyacrylates are also suitable, which are cross-linked using approximately 1% of a polyallyl ether of sucrose, for example, and which have a relative molecular mass greater than 1 million. Examples of these are the polymers available under the names Carbopol 940 and 941. The cross-linked polyacrylates are used in quantities of not greater than 1% by weight, preferably in quantities of 0.2 to 0.7% by weight. The detergents, cleaning agents, or disinfectants according to the invention can contain as foam inhibitors fatty acid alkyl ester alkoxylates, organopolysiloxanes, and the mixtures thereof with microfine, optionally silanized silicic acid and paraffins, waxes, microcrystalline waxes, and the mixtures thereof with silanized silicic acid. Mixtures of various foam inhibitors can advantageously also be used, e.g., those made of silicone oil, paraffin oil, or waxes. Foam inhibitors are preferably bound to a granulated carrier substance which is soluble or dispersible in water. The liquid detergents can contain optical lighteners, for example, derivatives of diaminostilbene disulfonic acid or the alkali metal salts thereof, which may be incorporated well into the dispersion. The maximum content of lighteners in the agents according to the invention is 0.5% by weight, quantities of 0.02 to 0.25% by weight are preferably used. The desired viscosity of the agents can be adjusted by adding water and/or organic solvents or by adding a combination of organic solvents and further thickeners. Fundamentally, all monovalent or multivalent alcohols come into consideration as the organic solvents. Preferably, alcohols having 1 to 4 carbon atoms such as methanol, ethanol, propanol, isopropanol, straight-chain and branched butanol, glycerin, and mixtures of the mentioned alcohols are used. Further preferred alcohols are polyethylene glycols having a relative molecular mass less than 2000. In particular, a use of polyethylene glycol having a relative molecular mass between 200 and 600 and in quantities up to 45% by weight and polyethylene glycol having a relative molecular mass between 400 and 600 in quantities of 5 to 25% by weight is preferred. An advantageous mixture of solvents consists of monomeric alcohol, for example, ethanol and polyethylene glycol in the ratio 0.5:1 to 1.2:1, the liquid detergent according to the invention being able to contain 8 to 12% by weight of such a mixture. Further suitable solvents are, for example, triacetin (glycerin triacetate) and 1-methoxy-2-propanol.

Preferably, hardened ricin oil, salts of long-chain fatty acids, preferably in quantities of 0 to 5% by weight and in particular in quantities of 0.5 to 2% by weight, for example, sodium, potassium, aluminum, magnesium, and titanium stearates or the sodium and/or potassium salts of behenic acid as well as polysaccharides, in particular xanthan gum, guar guar, agar agar, alginates and tyloses, carboxy methyl cellulose and hydroxyethyl cellulose, as well as higher-molecular-weight polyethylene glycol monoesters and diesters of fatty acids, polyacrylates, polyvinyl alcohol, and polyvinylpyrrolidone are preferably used as thickeners.

As enzymes, those from the class of proteases, lipases, amylases, or the mixtures thereof come into consideration. Their fraction can be 0.2 to 1% by weight. The enzymes can be absorbed on carrier substances and/or embedded in enveloping substances.

Organic or inorganic acids, preferably organic acids, particularly preferably alpha-hydroxy acids and acids selected from glycolic acid, lactic acid, citric acid, tartaric acid, mandelic acid, salicylic acid, ascorbic acid, pyruvic acid, oligooxa monocarboxylic and dicarboxylic acids, fumaric acid, retinoic acid, aliphatic and organic sulfonic acids, benzoic acid, kojic acid, fruit acid, malic acid, gluconic acid, galacturonic acid, acid plant and/or fruit extracts and the derivatives thereof come into consideration as acid additives. In order to bind traces of heavy metals, the salts of polyphosphoric acids, such as 1-hydroxy ethane-1,1-diphosphonic acid (HEDP) and diethylene triamine pentamethyl phosphonic acid (DTPMP), preferably in weight quantities of 0.1 to 1.0% by weight can be used. For example, phenoxy ethanol, parabens, pentanediol, or sorbate acid are suitable as preservatives. For example, glycol distearic acid esters such as ethylene glycol distearate, but also fatty acid monoglycol esters, come into consideration as pearlescent agents. For example, sodium sulfate, sodium carbonate, or sodium silicate (water glass) are used as salts or regulating agents. Typical individual examples of further additives are sodium borate, starch, saccharine, polydextrose, stilbene compounds, methyl cellulose, toluene sulfonate, cumol sulfonates, soaps, and silicone. The detergents, cleaning agents, or disinfectants according to the invention are typically set to a pH value in the range from 2 to 12, preferably pH 2.1 to 7.8, particularly preferably 2.2 to 6.5.

In a further preferred embodiment, the detergent, cleaning agent, or disinfectant is preferably substantially composed of naturally occurring ingredients.

In microbiological studies at the Institute for Hygiene at the Medical University of Innsbruck, it has surprisingly been shown that the hydrolysates according to the invention have a broad, sometimes pronounced antibacterial effect against harmful pathogens, which was significantly more pronounced in its antibacterial effect in corresponding tests than was the case with non-hydrolyzed extracts. Thus, for example, in antibacterial sensitivity tests using the agar diffusion test according to Mueller-Hinton (Mueller, H. J. and Hinton, J. (1941): A protein-free medium for primary isolation of the Gonococcus and Meningococcus. Proc. Soc. Expt. Biol. Med.; 48:330-333), it was shown that of the hydrolyzed individual drug extracts, the hydrolysates according to the invention were effective against multiple pathogens and the majority of non-hydrolyzed mixtures surprisingly displayed practically no antibacterial effect against the tested bacteria reference panel in the agar diffusion test.

In a further embodiment, the invention relates to a method for producing hydrolysates, obtainable from at least one aqueous/ethanolic extract from at least one plant (plant drug) according to the invention, an aqueous/ethanolic extract preferably being admixed with aqueous acid and subsequently the soluble fractions being collected (=hydrolysate).

The invention also relates to a method for producing a detergent, cleaning agent, or disinfectant, a preferably aqueous/ethanolic extract being produced from at least one plant (plant drug) according to the invention in a first step, and the obtained extract being admixed with an aqueous acid and the aqueous fractions being collected and optionally dried in a second step.

In a further embodiment of the invention, the obtained hydrolysates can be converted into a dry compound. In a preferred embodiment, freeze-drying of the hydrolysates is performed. Other drying methods are also usable, however.

Both the hydrolysates according to the invention and also the aqueous suspensions and dried compounds thereof display an antibacterial effect and therefore an advantageous disinfecting effect.

Reference is made to the technical teaching which is the subject matter of EP 1368605B1 and EP 0753306B1 on the production of the extracts according to the invention and the combinations thereof made of the plants.

Further advantages and features of the present invention result on the basis of the description of exemplary embodiments. The following examples serve to explain the invention without restricting the invention to these examples.

### EXAMPLES

### Preparation of the Test Solutions

The individual drugs and mixed extracts having variable drug compositions were extracted in 50% EtOH/H₂O (v/v, approximately 1 g plant material for 20 ml solvent) for 24 hours at room temperature while stirring. 1.6 ml extract were admixed with 320 μl 25% HCl (corresponding to 8.1 mol/l) and 80 μl 50% EtOH and hydrolyzed for 45 minutes at 90° C. For comparison, in a second step, the hydrolysis was conducted with 1 ml extract under the same conditions, while adding 1 ml 25% HCl. After concentrating the extracts by evaporation, the residue was received in 1 ml sterile water and tested for the antibacterial effect thereof. Screening method: 80 μl of the test solution were placed on Mueller Hinton agar plates, or Mueller Hinton Agar plates with 5% sheep blood, which contained an unknown concentration of the bacteria to be tested, and incubated for 24 hours at 37° C.

Spiral platter (SP): A bacteria colony was suspended in 5 ml CASO-Bouillon and incubated for 24 hours at 37° C. The supernatant was removed after centrifuging the sample, washed with 0.9% NaCl, and diluted to a concentration of 10⁷ cfu/ml (colony-forming units per milliliter). The test solutions were diluted 1:2, 1:20, and 1:200 and mixed with the bacteria suspension (for Pneumococcus and H. influenzae: 1:10, for the remaining pathogens 1:100). 0.9% NaCl was used for positive control purposes. The samples were plated with a Whitley Automatic Spiral Platter (WASP) after 0, 4, and 8 hours and incubated for 24 hours at 37° C.

Tables: Results of antimicrobial effect:

Screening tests: Individual drugs/mixed extract before hydrolysis

TABLE 1

| | Gentiana | Sambucus | Verbena | Rumex | Primula | 5 Pfl. |
|---|---|---|---|---|---|---|
| | l. | n. | o. | h. | v. | Extrakt |
| Staph. | Ø | Ø | Ø | + | +M | Ø |
| aureus | | | | | | |
| P. | Ø | +B | Ø | +B | Ø | Ø |
| aeruginosa | | | | | | |
| Pneumo- | Ø | Ø | Ø | +M | +M | Ø |
| coccus | | | | | | |
| Strept. | Ø | Ø | Ø | +M | +M | Ø |
| pyogenes | | | | | | |
| Klebsiella | Ø | Ø | Ø | Ø | Ø | Ø |
| E. Coli | Ø | Ø | Ø | Ø | Ø | Ø |
| H. influenzae | Ø | Ø | Ø | Ø | Ø | Ø |
| Staph. | Ø | Ø | Ø | + | Ø | Ø |
| epidermidis | | | | | | |
| Ent. faecalis | Ø | Ø | Ø | + | Ø | Ø |
| (VRE) | | | | | | |
| Ent. | Ø | Ø | Ø | +M | Ø | Ø |
| caselliflavus | | | | | | |
| (VRE) | | | | | | |

Results of the assay for antibacterial effects of the respective individual extracts Gentiana lutea (Gentiana l.), Sambucus nigra (Sambucus n.), Verbena officinalis (Verbena o.), Rumex herba (Rumex h.), and Primula veris (Primula v.) and a mixed extract of all five plants (5 Pfl. Extrakt = 5 plant extract) against the pathogenic agents Staphylococcus aureus (Staph. aureus), Pseudomonas aeruginosa (P. aeruginosa), Pneumococcus, Streptococcus pyogenes (Strept. pyogenes), Klebsiella, Escherichia coli (E. coli), Haemophilus influenzae H. influenzae), Staphylococcus epidermidis (Staph. epidermidis), Enterococcus faecalis (VRE) (Ent. faecalis (VRE)), and Enterococcus caselliflavus (VRE) (Ent. cassilliflavus (VRE)).
+M = antibacterial activity on Mueller Hinton agar;
+B = antibacterial activity on Mueller Hinton agar with 5% sheep blood;
+ = effect on both plates

Spiral platter: Rumex herba before hydrolysis

TABLE 2
Quantification of the antimicrobial effect of Rumex herba and of
Primula veris by means of spiral plating against the pathogens
mentioned in Table 1. The samples were each quantified in 1:20 or
1:200 dilutions.

| | |
|---|---|
| Rumex h. | Primula v. |

| | 1:20 | 1-200 | 1:20 | 1-200 |
|---|---|---|---|---|
| Staph. aureus | +++ | + | ++ | (+) |
| P. aeruginosa | Ø | Ø | Ø | Ø |
| Pneumococcus | ++++ | ++++ | ++++ | ++++ |
| Strept. pyogenes | ++++ | ++++ | ++++ | ++ |
| Klebsiella | Ø | Ø | Ø | Ø |
| E. coli | Ø | Ø | Ø | Ø |
| H. influenzae | Ø | Ø | Ø | Ø |
| Staph. epidermidis | ++ | ++ | Ø | Ø |
| Ent. faecalis (VRE) | ++++ | ++++ | Ø | Ø |
| Ent. caselliflavus (VRE) | ++++ | ++++ | Ø | Ø |

++++ = 10² cfu/ml after 0 hours,
+++ = 10² cfu/ml after 4 hours,
++ = 10² cfu/ml after 8 hours,
+ = 10³-10⁴ cfu/ml after 8 hours,
(+) = higher activity in comparison to the control group

Screening tests: Plant mixtures in various compositions, non-hydrolyzed

TABLE 3

| | RGVSP | RVSP | RGVP | RGSP | RGVS | GVSP | RVP | VSP | GVP | GVS | RSP |
|---|---|---|---|---|---|---|---|---|---|---|---|
| Staph. aureus | Ø | + | + | + | (+) | (+) | Ø | Ø | Ø | Ø | (+) |
| P. aeruginosa | Ø | Ø | Ø | Ø | Ø | Ø | Ø | Ø | Ø | Ø | Ø |
| Pneumococcus | Ø | Ø | Ø | Ø | Ø | Ø | (+) | Ø | Ø | Ø | Ø |
| Strept. pyogenes | Ø | Ø | Ø | Ø | Ø | Ø | Ø | Ø | Ø | Ø | + |
| Klebsiella | Ø | Ø | Ø | Ø | Ø | Ø | Ø | Ø | Ø | Ø | Ø |
| E. coli | Ø | Ø | Ø | Ø | Ø | Ø | Ø | Ø | Ø | Ø | Ø |
| H. influenzae | Ø | Ø | Ø | Ø | Ø | Ø | Ø | Ø | Ø | Ø | Ø |
| Staph. | Ø | Ø | Ø | Ø | Ø | Ø | Ø | Ø | Ø | Ø | Ø |
| epidermidis | | | | | | | | | | | |
| Ent. faecalis | Ø | Ø | Ø | Ø | Ø | Ø | Ø | Ø | Ø | Ø | Ø |
| (VRE) | | | | | | | | | | | |
| Ent. Caselliflavus | Ø | Ø | Ø | Ø | Ø | Ø | Ø | Ø | Ø | Ø | Ø |
| (VRE) | | | | | | | | | | | |

| | RGP | RGS | RGV | RVS | GSP |
|---|---|---|---|---|---|
| Staph. aureus | + | Ø | Ø | Ø | Ø |
| P. aeruginosa | Ø | Ø | Ø | Ø | Ø |
| Pneumococcus | Ø | Ø | Ø | Ø | Ø |
| Strept. pyogenes | Ø | + | Ø | Ø | Ø |
| Klebsiella | Ø | Ø | Ø | Ø | Ø |
| E. coli | Ø | Ø | Ø | Ø | Ø |
| H. influenzae | Ø | Ø | Ø | Ø | Ø |
| Staph. epidermidis | Ø | Ø | Ø | Ø | Ø |
| Ent. faecalis (VRE) | Ø | Ø | Ø | Ø | Ø |
| Ent. caselliflavus (VRE) | Ø | Ø | Ø | Ø | Ø |

50% ethanolic mixed extracts consisting of respectively 5, 4, or 3 plants were produced from the individual drugs mentioned in Table 1 and assayed for their antimicrobial effect against the pathogenic agents mentioned in Table 1 in screening tests.
Gentiana lutea (G), Sambucus nigra (S), Verbena officinalis (V), Rumex herba (R), and Primula veris (P).
+ = effect on both plates (Mueller Hinton agar, Mueller Hinton agar with 5% sheep's blood),
(+) = effect on one plate

Screening tests: Individual drug/mixed extract after hydrolysis

TABLE 4
The obtained extracts of the plant drugs mentioned in Table 1 and a
mixed extract consisting of all five plants were hydrolyzed by means of
hydrochloric acid and tested against the pathogenic agents mentioned
in Table 1 for antibacterial effect.

| | | | | | | 5 Pfl. |
|---|---|---|---|---|---|---|
| | Gentiana l. | Sambucus n. | Verbena o. | Rumex h. | Primula v. | Extrakt |
| Staph. aureus | + | + | Ø | Ø | + | + |
| P. aeruginosa | + | (+) | Ø | Ø | + | + |
| Pneumococcus | + | + | + | Ø | + | + |
| Strept. | + | + | + | Ø | + | + |
| pyogenes | | | | | | |
| Klebsiella | + | (+) | Ø | Ø | + | + |
| E. coli | + | Ø | Ø | Ø | + | + |
| H. influenzae | + | + | Ø | Ø | + | + |
| Staph. | + | + | + | Ø | + | + |
| epidermidis | | | | | | |
| Ent. faecalis | + | Ø | Ø | Ø | + | + |
| (VRE) | | | | | | |
| Ent. | + | Ø | Ø | Ø | + | + |
| caselliflavus | | | | | | |
| (VRE) | | | | | | |

The extracts were concentrated by vaporization until dry after completed hydrolysis and dissolved in sterile water.
+ M = antibacterial activity on Mueller Hinton agar;
+ = effect on both plates (Mueller Hinton agar, Mueller Hinton agar with 5% sheep's blood),
(+) = effect on one plate

Spiral plate: Quantification of the individual drugs or of the 5-plant extract

TABLE 5
Quantification of the obtained hydrolysates of the plant drugs mentioned in Table 1 and
of the 5-plant extract by means of spiral plating against the pathogens mentioned in
Table 1. All solutions were measured in 1:20 dilution.

| | | | | | 5 Pfl. |
|---|---|---|---|---|---|
| | Gentiana l. | Sambucus n. | Verbena o. | Primula v. | Extrakt |
| Staph. aureus | (+) | (+) | + | +++ | (+) |
| P. aeruginosa | ++++ | +++ | ++++ | ++++ | ++++ |
| Pneumococcus | +++ | + | (+) | ++++ | |
| Strept. pyogenes | ++++ | ++++ | ++++ | ++++ | ++++ |
| Klebsiella | +++ | ++ | ++ | +++ | +++ |
| E. coli | +++ | (+) | (+) | + | + |
| H. influenzae | ++++ | ++++ | ++++ | ++++ | ++++ |
| Staph. epidermidis | +++ | +++ | +++ | ++++ | +++ |
| Ent. faecalis (VRE) | +++ | ++ | + | +++ | +++ |
| Ent. caselliflavus (VRE) | +++ | ++ | +++ | +++ | +++ |

++++ = 10² cfu/ml after 0 hours,
+++ = 10² cfu/ml after 4 hours,
++ = 10² cfu/ml after 8 hours,
+ = 10³-10⁴ cfu/ml after 8 hours,
(+) = higher activity in comparison to the control group

Comparison of the reproducibility of the antibacterial effect

TABLE 6
Study of the reproducibility of the antibacterial effectiveness of multiple extracts of the
same individual drugs (Sambucus nigra, Gentiana lutea, Primula veris).
Quantification by means of spiral plating in 1:20 dilution of the sample.

| | Extrakt 1 | Extrakt 2 | Extrakt 3 |
|---|---|---|---|
| Sambucus n. | | | |
| Staph. aureus | (+) | (+) | (+) |
| P. aeruginosa | +++ | +++ | ++++ |
| Pneumococcus | + | ++ | |
| Strept. Pyogenes | ++++ | +++ | +++ |
| Klebsiella | ++ | (+) | +++ |
| E. coli | (+) | (+) | |
| H. influenzae | ++++ | ++++ | |
| Staph. epidermidis | +++ | ++ | ++++ |
| Ent. faecalis (VRE) | ++ | (+) | ++ |
| Ent. caselliflavus (VRE) | ++ | ++ | +++ |
| Gentiana l. | | | |
| Staph. aureus | (+) | (+) | (+) |
| P. aeruginosa | ++++ | ++++ | ++++ |
| Pneumococcus | +++ | ++++ | |
| Strept. pyogenes | ++++ | ++++ | ++++ |
| Klebsiella | +++ | +++ | ++++ |
| E. coli | +++ | + | ++++ |
| H. influenzae | ++++ | ++++ | |
| Staph. epidermidis | +++ | +++ | ++++ |
| Ent. faecalis (VRE) | +++ | ++ | +++ |
| Ent. caselliflavus (VRE) | +++ | +++ | ++++ |

| Primula v. | Extrakt 1 | Extrakt 2 | Extrakt 3 | Extrakt 4 | Extrakt 5 |
|---|---|---|---|---|---|
| Staph. aureus | +++ | (+) | ++ | (+) | + |
| P. aeruginosa | ++++ | +++ | ++++ | ++++ | ++++ |
| Pneumococcus | ++++ | (+) | +++ | +++ | +++ |
| Strept. pyogenes | ++++ | +++ | ++++ | ++++ | +++ |
| Klebsiella | +++ | (+) | ++++ | + | +++ |
| E. coli | + | (+) | +++ | ++ | + |
| H. influenzae | ++++ | +++ | ++++ | ++++ | ++++ |
| Staph. epidermidis | ++++ | (+) | +++ | +++ | +++ |
| Ent. faecalis (VRE) | +++ | (+) | +++ | + | + |
| Ent. caselliflavus (VRE) | +++ | ++ | +++ | +++ | ++ |

++++ = 10² cfu/ml after 0 hours,
+++ = 10² cfu/ml after 4 hours,
++ = 10² cfu/ml after 8 hours,
+ = 10³-10⁴ cfu/ml after 8 hours,
(+) = higher activity in comparison to the control group
Extrakt = extract

TABLE 7
Tested extracts

| | | Equiseti | | Juglandis | | Millefolii | | Querous | | Taraxaci | | Althaeae | | Matricariae | |
|---|---|---|---|---|---|---|---|---|---|---|---|---|---|---|---|
| | | Platte | SP | Platte | SP | Platte | SP | Platte | SP | Platte | SP | Platte | SP | Platte | SP |
| 1 | Staph. | Ø | | (+) | | Ø | | + | | Ø | | Ø | | Ø | |
| | aureus | | | | | | | | | | | | | | |
| 2 | P. aeroginosa | Ø | | (+) | | Ø | | + | | Ø | | Ø | | Ø | |
| 3 | Pneumococcus | + | | Ø | | Ø | | Ø | | Ø | | Ø | | Ø | |
| 4 | Streptococcus | Ø | | + | | Ø | | + | | Ø | | Ø | | Ø | |
| | pyogenes | | | | | | | | | | | | | | |
| 5 | Klebaiella | Ø | | + | | Ø | | + | | Ø | | Ø | | Ø | |
| 6 | E. coli | Ø | | Ø | | Ø | | Ø | | Ø | | Ø | | Ø | |
| 7 | H. influenzae | Ø | | Ø | | Ø | | (+) | | Ø | | Ø | | Ø | |
| 8 | Staph. | Ø | | + | | Ø | | + | | Ø | | Ø | | Ø | |
| | epidermidis | | | | | | | | | | | | | | |
| 9 | Ent. | Ø | | Ø | | Ø | | (+) | | Ø | | Ø | | Ø | |
| | faecalis | | | | | | | | | | | | | | |
| | (VRE) | | | | | | | | | | | | | | |
| 10 | Ent. | Ø | | Ø | | Ø | | Ø | | Ø | | Ø | | Ø | |
| | casilliflavus | | | | | | | | | | | | | | |
| | (VRE) | | | | | | | | | | | | | | |
| | | Althaeae | | Equiseti | | Taraxaci | | Quercus | | Matricariae | | Millefolii | | Juglandis | |
| | | hydrolysiert | | hydrolysiert | | hydrolysiert | | hydrolysiert | | hydrolysiert | | hydrolysiert | | hydrolysiert | |
| | | Platte | SP | Platte | SP | Platte | SP | Platte | SP | Platte | SP | Platte | SP | Platte | SP |
| 1 | Staph. | Ø | | (+) | | Ø | | + | | Ø | | (+) | | Ø | |
| | aureus | | | | | | | | | | | | | | |
| 2 | P. aeroginosa | Ø | | (+) | | Ø | | + | | (+) | | (+) | | Ø | |
| 3 | Pneumococcus | + | | + | | Ø | | (+) | | + | | + | | + | |
| 4 | Streptococcus | Ø | | Ø | | Ø | | + | | (+) | | (+) | | Ø | |
| | pyogenes | | | | | | | | | | | | | | |
| 5 | Klebsiella | Ø | | (+) | | Ø | | (+) | | Ø | | Ø | | Ø | |
| 6 | E. coli | Ø | | (+) | | Ø | | (+) | | Ø | | Ø | | Ø | |
| 7 | H. influenzae | + | | (+) | | Ø | | + | | (+) | | (+) | | Ø | |
| 8 | Staph. | Ø | | (+) | | Ø | | + | | Ø | | (+) | | Ø | |
| | epidermidis | | | | | | | | | | | | | | |
| 9 | Ent. | Ø | | (+) | | Ø | | + | | Ø | | (+) | | Ø | |
| | faecalis | | | | | | | | | | | | | | |
| | (VRE) | | | | | | | | | | | | | | |
| 10 | Ent. | Ø | | (+) | | Ø | | (+) | | (+) | | Ø | | Ø | |
| | casilliflavus | | | | | | | | | | | | | | |
| | (VRE) | | | | | | | | | | | | | | |

+ effect on both plates;
(+) effect on one plate;
Ø no effect

TABLE 8
Analysis:
“+” = antibacterial activity;
“(+)” = slight antibacterial activity,
“Ø” = no activity
Composition Canephron:
Results of the antibacterial activity

| | Centaurium | | Levisticum | | Rosmarinus | |
|---|---|---|---|---|---|---|
| | erythraea | | officinale | | officinalis | |
| | no | | no | | no | |
| Bacterial strains | hydrol. | hydrol. | hydrol. | hydrol. | hydrol. | hydrol. |
| Staphylococcus aureus | Ø | + | Ø | + | + | + |
| Pseudomonas aeruginosa | Ø | + | Ø | + | Ø | + |
| Streptococcus pneumonia | Ø | + | Ø | + | (+) | + |
| Streptococcus pyogenes | Ø | + | Ø | + | + | + |
| Klebsiella pneumoniae | Ø | + | Ø | + | (+) | (+) |
| Escherichia coli | Ø | (+) | Ø | + | Ø | Ø |
| Haemophilus influenzae | Ø | (+) | Ø | + | Ø | + |
| Staphylococcus | Ø | Ø | Ø | + | + | + |
| epidermidis | | | | | | |
| Enterococcus faecalis | Ø | Ø | Ø | (+) | + | + |
| (VRE) | | | | | | |
| Enterococcus | Ø | (+) | Ø | + | + | + |
| casseliflavus (VRE) | | | | | | |

TABLE 9
Analysis:
“+” = antibacterial activity;
“(+)” = slight antibacterial activity,
“Ø” = no activity
Results of the antibacterial activity

| | Angelica | | Angelica | | Artemisia | |
|---|---|---|---|---|---|---|
| | dahurica | | sinensis | | scoparia | |
| Bacterial | no | | no | | no | |
| strains | hydrol. | hydrol. | hydrol. | hydrol. | hydrol. | hydrol. |
| Staphylococcus | Ø | + | Ø | + | Ø | Ø |
| aureus | | | | | | |
| Pseudomonas | Ø | + | Ø | + | Ø | + |
| aeruginosa | | | | | | |
| Streptococcus | Ø | + | + | + | Ø | (+) |
| pneumonia | | | | | | |
| Streptococcus | Ø | + | Ø | + | Ø | (+) |
| pyogenes | | | | | | |
| Klebsiella | Ø | + | Ø | + | Ø | Ø |
| pneumoniae | | | | | | |
| Escherichia | Ø | + | Ø | + | Ø | Ø |
| coli | | | | | | |
| Haemophilus | Ø | + | Ø | + | Ø | + |
| influenzae | | | | | | |
| Staphylococcus | Ø | + | Ø | + | Ø | Ø |
| epidermidis | | | | | | |
| Enterococcus | Ø | + | Ø | (+) | Ø | Ø |
| faecalis (VRE) | | | | | | |
| Enterococcus | Ø | + | Ø | + | Ø | Ø |
| casseliflavus | | | | | | |
| (VRE) | | | | | | |
| | Saposhnikovia | | Scutellaria | | Siegesbeckia | |
| | divaricata | | baicalensis | | pubescens | |
| Bacterial | no | | no | | no | |
| strains | hydrol. | hydrol. | hydrol. | hydrol. | hydrol. | hydrol. |
| Staphylococcus | Ø | + | Ø | + | Ø | (+) |
| aureus | | | | | | |
| Pseudomonas | Ø | + | Ø | Ø | Ø | + |
| aeruginosa | | | | | | |
| Streptococcus | Ø | + | Ø | + | Ø | + |
| pneumonia | | | | | | |
| Streptococcus | Ø | + | Ø | (+) | Ø | + |
| pyogenes | | | | | | |
| Klebsiella | Ø | + | Ø | (+) | Ø | + |
| pneumoniae | | | | | | |
| Escherichia | Ø | + | Ø | (+) | Ø | (+) |
| coli | | | | | | |
| Haemophilus | Ø | + | Ø | + | Ø | (+) |
| influenzae | | | | | | |
| Staphylococcus | Ø | + | Ø | Ø | Ø | (+) |
| epidermidis | | | | | | |
| Enterococcus | Ø | + | Ø | (+) | Ø | (+) |
| faecalis | | | | | | |
| (VRE) | | | | | | |
| Enterococcus | Ø | + | Ø | Ø | Ø | (+) |
| casseliflavus | | | | | | |
| (VRE) | | | | | | |

TABLE 10
Analysis:
“+” = antibacterial activity;
“(+)” = slight antibacterial activity,
“Ø” = no activity
Results of the antibacterial activity

| | |
|---|---|
| Armoracia | |
| rusticana | Capsicum sp. |

| Bacterial strains | no hydrol. | hydrol. | no hydrol. | hydrol. |
|---|---|---|---|---|
| Staphylococcus aureus | Ø | + | Ø | + |
| Pseudomonas aeruginosa | Ø | + | Ø | + |
| Streptococcus pneumonia | Ø | + | + | + |
| Streptococcus pyogenes | Ø | + | Ø | + |
| Klebsiella pneumoniae | Ø | + | Ø | + |
| Escherichia coli | Ø | + | Ø | + |
| Haemophilus influenzae | Ø | + | Ø | + |
| Staphylococcus epidermidis | Ø | + | Ø | + |
| Enterococcus faecalis (VRE) | Ø | + | Ø | + |
| Enterococcus casseliflavus | Ø | + | Ø | + |
| (VRE) | | | | |

| | | | Ech. | | Ech. | |
|---|---|---|---|---|---|---|
| | Cistus | | purpurea | | purpurea | |
| | incanus | | radix | | herba | |
| | no | | no | | no | |
| Bacterial strains | hydrol. | hydrol. | hydrol. | hydrol. | hydrol. | hydrol. |
| Staphylococcus aureus | + | + | Ø | + | Ø | (+) |
| Pseudomonas aeruginosa | Ø | + | Ø | + | Ø | + |
| Streptococcus pneumonia | (+) | + | Ø | + | Ø | + |
| Streptococcus pyogenes | (+) | + | Ø | + | Ø | + |
| Klebsiella pneumoniae | Ø | + | Ø | + | Ø | + |
| Escherichia coli | Ø | + | Ø | + | Ø | (+) |
| Haemophilus influenzae | Ø | + | Ø | + | Ø | (+) |
| Staphylococcus | + | + | Ø | + | Ø | Ø |
| epidermidis | | | | | | |
| Enterococcus faecalis | + | + | Ø | + | Ø | + |
| (VRE) | | | | | | |
| Enterococcus | Ø | + | Ø | + | Ø | Ø |
| casseliflavus (VRE) | | | | | | |
| | Galphimia | | Hedera | | Melia | |
| | glauca | | helicis | | toosendan | |
| | no | | no | | no | |
| Bacterial strains | hydrol. | hydrol. | hydrol. | hydrol. | hydrol. | hydrol. |
| Staphylococcus aureus | (+) | (+) | Ø | (+) | Ø | + |
| Pseudomonas aeruginosa | Ø | Ø | Ø | + | Ø | + |
| Streptococcus pneumonia | Ø | + | (+) | + | + | + |
| Streptococcus pyogenes | (+) | + | + | (+) | Ø | + |
| Klebsiella pneumoniae | Ø | Ø | Ø | + | Ø | + |
| Escherichia coli | Ø | Ø | Ø | (+) | Ø | + |
| Haemophilus influenzae | Ø | (+) | + | (+) | Ø | + |
| Staphylococcus | (+) | (+) | (+) | Ø | Ø | + |
| epidermidis | | | | | | |
| Enterococcus faecalis | Ø | Ø | Ø | Ø | Ø | + |
| (VRE) | | | | | | |
| Enterococcus | Ø | + | Ø | + | Ø | + |
| casseliflavus (VRE) | | | | | | |
| | Olea | | Pelargonium | | Phytolacca | |
| | europaea | | sp. | | Americana | |
| | no | | no | | no | |
| Bacterial strains | hydrol. | hydrol. | hydrol. | hydrol. | hydrol. | hydrol. |
| Staphylococcus aureus | + | + | + | + | Ø | + |
| Pseudomonas aeruginosa | Ø | + | Ø | + | Ø | + |
| Streptococcus pneumonia | Ø | + | Ø | + | Ø | Ø |
| Streptococcus pyogenes | Ø | + | + | + | Ø | Ø |
| Klebsiella pneumoniae | (+) | + | Ø | + | Ø | + |
| Escherichia coli | Ø | + | Ø | + | Ø | + |
| Haemophilus influenzae | Ø | + | Ø | + | Ø | Ø |
| Staphylococcus | + | + | + | + | Ø | + |
| epidermidis | | | | | | |
| Enterococcus faecalis | Ø | + | + | + | Ø | + |
| (VRE) | | | | | | |
| Enterococcus | Ø | + | + | + | Ø | Ø |
| casseliflavus (VRE) | | | | | | |
| | Primula veris | | | | | |
| | radix | | Salix sp. | | Thymus L. | |
| | no | | no | | no | |
| Bacterial strains | hydrol. | hydrol. | hydrol. | hydrol. | hydrol. | hydrol. |
| Staphylococcus aureus | + | + | + | + | + | + |
| Pseudomonas aeruginosa | Ø | + | + | + | Ø | + |
| Streptococcus pneumonia | + | + | + | + | Ø | + |
| Streptococcus pyogenes | + | + | + | + | + | + |
| Klebsiella pneumoniae | Ø | + | + | + | Ø | + |
| Escherichia coli | Ø | + | + | + | Ø | + |
| Haemophilus influenzae | (+) | + | + | (+) | Ø | (+) |
| Staphylococcus | (+) | Ø | + | + | Ø | + |
| epidermidis | | | | | | |
| Enterococcus faecalis | (+) | (+) | + | + | Ø | + |
| (VRE) | | | | | | |
| Enterococcus | Ø | (+) | + | + | Ø | + |
| casseliflavus (VRE) | | | | | | |
| | Vitex agnus | | Vitis | | Ech. | |
| | castus | | vinifera | | Angustifolia | |
| | no | | no | | no | |
| Bacterial strains | hydrol. | hydrol. | hydrol. | hydrol. | hydrol. | hydrol. |
| Staphylococcus aureus | Ø | + | + | + | Ø | + |
| Pseudomonas aeruginosa | Ø | + | Ø | + | Ø | + |
| Streptococcus pneumonia | Ø | + | Ø | + | Ø | + |
| Streptococcus pyogenes | (+) | + | Ø | + | Ø | + |
| Klebsiella pneumoniae | Ø | + | Ø | + | Ø | + |
| Escherichia coli | Ø | (+) | Ø | + | Ø | + |
| Haemophilus influenzae | Ø | + | Ø | + | Ø | + |
| Staphylococcus | Ø | (+) | Ø | + | Ø | + |
| epidermidis | | | | | | |
| Enterococcus faecalis | Ø | + | Ø | + | Ø | + |
| (VRE) | | | | | | |
| Enterococcus | Ø | (+) | Ø | + | Ø | + |
| casseliflavus (VRE) | | | | | | |

Disk diffusion assay of TCM drugs

| | Huang qi | | Ch. motherwort | | Red sage | |
|---|---|---|---|---|---|---|
| | no | | no | | no | |
| Bacterial strains | hydrol. | hydrol. | hydrol. | hydrol. | hydrol. | hydrol. |
| Staphylococcus aureus | Ø | + | Ø | + | + | + |
| Pseudomonas aeruginosa | Ø | + | Ø | + | Ø | + |
| Streptococcus pneumoniae | Ø | + | (+) | + | + | + |
| Streptococcus | Ø | + | + | + | (+) | + |
| pyogenes | | | | | | |
| Klebsiella pneumoniae | Ø | + | (+) | + | Ø | + |
| Escherichia coli | Ø | + | Ø | + | Ø | + |
| Haemophilus influenzae | Ø | + | Ø | + | Ø | + |
| Staphylococcus | Ø | + | Ø | + | + | + |
| epidermidis | | | | | | |
| Enterococcus faecalis | Ø | + | Ø | + | + | + |
| (VRE) | | | | | | |
| Enterococcus | Ø | + | Ø | + | + | + |
| casseliflavus | | | | | | |
| (VRE) | | | | | | |

Ech. = Echinacea
Legend:
Huang qi (Astragalus membranaceus),
Chinese motherwort (Leonurus japonicus),
Red sage (Salvia miltiorrhiza).

The MIC of the cultivated bacteria is determined according to DIN58940-1. The minimal inhibiting concentration, MIC in short, is the smallest active ingredient concentration of an antimicrobial substance (e.g., an antibiotic), which still prevents the pathogen reproduction in the culture. MIC 90: minimal inhibiting concentration for 90% of the tested strains. A statement about the effectiveness of an antibiotic or the resistance of a specific pathogen may be made on the basis of the minimal inhibiting concentration. The determination is performed by various methods of antibiotic resistance testing, e.g., by the agar dilution test, the plate diffusion test, or an E test and is typically specified in μg/ml.

The agar dilution test was applied: 10 mL of a brain heart infusion (BHI) or Fildes broth (for H. Influenza) was inoculated with five colonies of the bacteria strains and subcultivated for 18-22 hours at 36+/−1° C. with 50 or 100 μL of a standardized bacteria suspension in the culture for 2.5 hours at 36+/−1° C. Subsequently, the bacteria cultures were centrifuged and resuspended in sodium phosphate buffer (10 mM, pH 7.2-7.4) until reaching a total concentration of 10⁵ colonies (colony forming units/milliliters or cfu/ml). Immediately after standardization of the growing inoculum, 100 μL of the bacteria test strain was added to the extract test solution in 96-well microtitration plates. Positive growth controls of bacteria strains in the extract test solutions were performed using basal medium.

Determination of the endpoints: MIC 90 values were determined by counting the colonies according to DIN 59049-7, two hours after incubation, with slight modifications, as follows: 100 μL of a bacteria culture were admixed in a test tube with 1 ml of a sterile 0.9% sodium chloride solution, followed by a tenfold dilution in each case, 10¹, 10², and 10³. 100 μL was then removed and painted twice on an agar plate, an action time of 18-24 hours at 36+/−1° C. in the presence of room air or CO₂ for Streptococcus sp. occurring. The cfu/ml (or mg/ml) were then ascertained and extrapolated. All tests were performed twice simultaneously and the arithmetic mean was determined.

TABLE 11
Results:

| | |
|---|---|
| MIC₉₀ in [mg/ml] | Primulae radix |

| Gram-positive | non hydrol. | hydrol. |
|---|---|---|
| Staph. aureus | 0.025 | 6.25 |
| Staph. aureus (MRSA¹) | 0.2 | 3.125 |
| Staph. | 0.2 | 3.125 |
| epidermidis | | |
| Strep. pyogenes | 0.025 | 3.125 |
| Strep. | 0.025 | 3.125 |
| pneumoniae | | |
| Strep. mutans | * | 3.125 |
| Ent. faecalis (VRE²) | 0.1 | 6.25 |

| MIC₉₀ | | | Primul. | Levistici | |
|---|---|---|---|---|---|
| in [mg/ml] | Primulae flos | | radix | radix | |
| Gram-negative | non hydrol. | hydrol. | hydrol. | non hydrol. | hydrol. |
| Escherichia | * | 12.5 | 3.125 | * | 6.25 |
| coli | | | | | |
| Pseudomonas | * | 12.5 | 3.125 | * | 6.25 |
| aeruginosa | | | | | |
| Haemoph. | 3.125 | 6.25 | 3.125 | 0.2 | 6.25 |
| influenzae | | | | | |
| Haemoph. | 1.56 | 3.125 | 3.125 | 0.2 | 1.56 |
| influenzae | | | | | |
| Klebsiella | 1.56 | 12.5 | 3.125 | * | 6.25 |
| pneumoniae | | | | | |
| Klebsiella | 6.25 | 12.5 | 3.125 | * | 6.25 |
| pneumoniae | | | | | |
| (ESBL³) | | | | | |
| Burkholderia | 12.5 | 12.5 | 3.125 | * | 6.25 |
| cepacia | | | | | |

Guaiacum

| Bakterienstämme | no hydrol. | hydrol. |
|---|---|---|
| Staph. aureus | + | + |
| Ps. aeruginosa | (+) | Ø |
| Strep. pyogenes | + | + |
| Strep. pneumoniae | (+) | (+) |
| K. pneumoniae | Ø | Ø |
| E. coli | + | + |
| Haemoph. influenzae | + | + |

MRSA¹: multiresistant Staphylococcus aureus;
VRE²: vancomycin resistant enterococcus
n.d.: Not determined;
*>25 mg/mL
ESBL³: extended spectrum beta lactamase
Baktereinstämme = bacterial strains

TABLE 12
MBC and MIC 90/MIC 50 against Legionella pneumophila

| | MBC | | MIC90 | | MIC50 | |
|---|---|---|---|---|---|---|
| | μg/ml | t in [h] | μg/ml | t in [h] | μg/ml | t in [h] |
| Levistici radix | >1000 | >24 | >1000 | >24 | >1000 | >24 |
| Levistici radix | 10 | 2 | 2.5 | 8 | 2.5 | 2 |
| hydrolysiert | | | | | | |
| Rosmarini | >1000 | >24 | >1000 | >24 | 250 | 16 |
| folium | | | | | | |
| Rosmarini | 100 | 8 | 100 | 2 | 100 | 2 |
| folium | | | | | | |
| hydrolysiert | | | | | | |
| Centaurii herba | >1000 | >24 | >1000 | >24 | >1000 | >24 |
| Centaurii herba | 2.5 | 24 | 2.5 | 8 | 2.5 | 2 |
| hydrolysiert | | | | | | |
| Canephron ® | >1000 | >24 | >1000 | >24 | 250 | 24 |
| Canephron ® | 10 | 2 | 2.5 | 8 | 2.5 | 2 |
| hydrolysiert | | | | | | |

Minimal bactericidal concentrations (MBC), minimal inhibitory concentrations (MIC)

1-10. (canceled)

11. An agent for application in the case of disinfection outside the human or animal body containing a hydrolysate made of an extract, which is produced by extraction from dried plant material, wherein the hydrolysate is obtainable from the extract by hydrolytic treatment using a mineral acid.

12. A detergent, cleaning agent, or disinfectant containing a hydrolysate made of at least one extract, which is produced by extraction from dried plant material, made of:
a) at least one of the plants selected from the group consisting of at least one genus: Althaeae, Angelica(e), Armoracia, Artemisia, Astragalus, Capsicum, Centaurium, Cistus, Echinacea, Equiseti, Galphimia, Gentiana, Guaiacum, Hedera, Juglandis, Leonurus, Levisticum, Matricariae, Melia, Millefolii, Olea, Pelargonium, Phytolacca, Primula, Quercus, Rosmarinus, Rumicis, Salix, Salvia, Sambucus, Saposhnikovia, Scutellaria, Siegesbeckia, Taraxaci, Thymus, Verbena, Vitex, Vitis; and a mixture or subcombination thereof; and/or
b) at least one of the plants selected from the group consisting of at least one species: Althaeae radix (marshmallow root), Angelica(e) dahurica (dahurian angelica), Angelica(e) sinensis (Chinese angelica), Armoracia rusticana (horseradish), Artemisia scoparia (redstem wormwood), Astragalus membranaceus (var. mongolicus) (Chinese milk vetch), Capsicum sp., Capsicum annuum (pepper), Centaurium erythraea (common centaury), Cistus incanus (hairy rockrose), Echinacea angustifolia (narrow-leaved purple coneflower), Echinacea purpurea (Eastern purple coneflower), Equiseti herba (horsetail), Galphimia glauca, Gentiana lutea L. (great yellow gentian), Guaiacum officinalis, Hederae folium, Hedera helicis (ivy), Juglandis folium (walnut leaf), Leonurus japonicus (Chinese motherwort), Levesticum radix, Levisticum officinalis (lovage), Matricariae flos (or Flos chamomillae (chamomile flower)), Melia toosendan (chinaberry fruit), Millefolii herba (yarrow), Olea europaea (olive), Pelargonium sp. (geranium), Phytolacca americana (American pokeweed), Primulae flos, Primulae radix, Primula veris L. (cowslip), Quercus cortex (oak bark), Rosmarinus officinalis (rosemary), Rumicis herba (sorrel herb), Salix sp. (willow), Salvia miltiorrhiza (red sage), Sambucus nigra L. (black elder), Saposhnikovia divaricata (siler), Scutellaria baicalensis (Baikal skullcap), Siegesbeckia pubescens (Siegesbeckia), Taraxaci herba (dandelion root herb), Thymus L. (thyme), Verbena officinalis L. (vervain), Vitex agnus castus (monk's pepper), Vitis vinifera (common grapevine), and a mixture or subcombination thereof,
wherein the hydrolysate is obtainable from the extract by hydrolytic treatment with a mineral acid.

13. The detergent, cleaning agent, or disinfectant containing a hydrolysate of claim 11, wherein the extracts are producible by means of an extraction agent made of 40 to 60% by volume ethanol and 40 to 60% by volume water from the plant material over 6 to 36 hours, in particular 12 to 30 hours, with stirring and optional vacuum concentration by evaporation of the solvent.

14. The detergent, cleaning agent, or disinfectant containing a hydrolysate of claim 11, wherein it is obtainable by hydrolytic treatment of the extracts with hydrochloric acid as the mineral acid in a concentration of 1 M to 10 Mat 80 to 100° C. for 30 to 120 min and/or the final solution has a concentration of the hydrochloric acid of 1 to 4 M.

15. The detergent, cleaning agent, or disinfectant containing hydrolysate of claim 11, wherein the hydrolysate has an antibacterial effect.

16. The detergent, cleaning agent, or disinfectant containing hydrolysate of claim 11, wherein the content is up to 30% by weight.

17. The detergent, cleaning agent, or disinfectant of claim 11, in the form of powders, granules, tablets or in liquid form as acid, aqueous, aqueous/acid, aqueous/organic, aqueous/acid/organic, aqueous/alcoholic, aqueous/acid/alcoholic, or organic formulations, emulsions, dispersions, gels, and suspensions.
